(19) United States
(12) Patent Application Publication
(10) Pub. No.: US 2009/0259826 A1
(43) Pub. Date: Oct. 15, 2009

(54) Microprocessor Extended Instruction Set Mode

(75) Inventor: Charles H. Moore, Sierra City, CA (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/270,661

(22) Filed: Nov. 13, 2008

Related U.S. Application Data
(60) Provisional application No. 61/124,174, filed on Apr. 15, 2008.

(51) Int. Cl. G06F 9/30; G06F 15/76; G06F 9/06

(52) U.S. Cl. 712/41; 712/229; 712/E09.003; 712/E09.016

(57) ABSTRACT

Disclosed is a system and method of adding functionality to a microprocessor, especially a RISC machine having a plurality of cores, with minimal changes in circuitry and while maintaining legacy features. An enhancement to the microprocessor involves modifying a program counter register (P-register). This invention increases the number of bits in the P-register from 9 to 10. A tenth bit signals an extended instruction mode. When the tenth bit is not set, microprocessor instructions perform legacy functions. When the tenth bit is set, the extended instruction mode is active and instructions perform different or enhanced functions.

### CROSS-REFERENCE TO RELATED APPLICATIONS

This application claims the benefit of U.S. Provisional Patent Application Ser. No. 61/124,174 entitled “Improvements for a Computer Array Chip”, filed on Apr. 15, 2008, which is incorporated herein by reference in its entirety.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to the field of microprocessors and more specifically to increasing functionality while maintaining relative simplicity of reduced instruction set computers.

### BACKGROUND OF THE INVENTION

A reduced instruction set computer (RISC) sacrifices code density to simplify implementation and to increase performance compared to a complex instruction set computer (CISC). The RISC, shown schematically in FIG. 2, has a fixed width for both the instructions as part of an instruction set and an instruction word register executing the instructions. Fixed length instructions typically implement only a single operation such as a bit shift of contents of a single register or data transfer from one register to another. In contrast, a CISC instruction set may have variable length instructions and also have variable length instruction words.

An advantage of the RISC is that it can execute instructions faster than equivalent instructions executed by the CISC. However, there is a limit to the possible number of instructions that can fit in the RISC instruction word. Therefore, once the possible bit combinations for instructions have been used, new instructions cannot be added to the instruction word. Nonetheless, regardless of how well designed an instruction set may have been when it was first developed, it may need to be extended. An extension may be in the form of new instructions, a change to one or more existing instructions, or the replacement of an existing instruction with a new instruction. A goal of the extension is to increase the functionality of the RISC while maintaining its speed advantage.

Even if new instructions are somehow added, there is the problem of maintaining the legacy features of the original instructions. There is another problem that adding instructions to increase the functionality of a RISC machine may involve significant manipulation to existing circuitry. Extra or more complex circuitry can lead to greater timing problems, execution errors, and greater power demands. Thus, any time a change is made to the existing transistor layout of a microprocessor, whether this change is in the form of addition or removal of elements, the microprocessor should be retested. This can be a complex and time consuming task.

Therefore, there is a need to change the result of an execution of an instruction by a RISC, without changing the instruction within the instruction set. This can have the benefit of maintaining the same instruction set for the instruction word while increasing functionality. In addition, having this option of executing either version of the same instruction maintains legacy features and keep changes in microprocessor circuitry to a minimum.

This application discloses a method and apparatus to gain additional functionality of a microprocessor, with minimal changes in circuitry, by adding an extended instruction set mode. In this mode, the result of executing an instruction may be changed without changing the instruction itself.

### SUMMARY OF THE INVENTION

The present invention relates to adding functionality to a microprocessor, especially a RISC machine having a plurality of cores, with minimal changes in circuitry and while maintaining legacy features.

Microprocessor instructions have a given instruction set whose members perform respective functions. In an extended instruction set mode, the same instructions perform different respective functions.

An enhancement to the microprocessor in this invention involves a program counter register (P-register). Ordinarily, the P-register, in the control unit of a CPU, keeps track of the current or next instruction. Typically, when the program counter advances to the next instruction, the CPU executes the current instruction. This invention increases the number of bits in the P-register from 9 to 10, permitting the addition of an extended instruction set mode.

If the tenth bit of the P-register is set high, the extended instruction set mode is active. Instructions that are executed while the P-register has its tenth bit set high are executed in the extended instruction set mode. If the tenth bit of the P-register is set low, the extended instruction set mode is not active. Instructions that are executed while the P-register has its tenth bit set low are executed in the non-extended instruction set mode.

Accordingly, it is an object of the invention to alter the results of executing instructions of an existing instruction set by changing functions of the instructions when executed in an extended instruction set mode. It is another object of the invention to utilize a program counter register for entering and exiting an extended instruction set mode.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE FIGURES

The purposes and advantages of the present invention will be apparent from the following detailed description in conjunction with the appended figures of drawings and tables in which:

FIG. 1 is a diagrammatic view of a computer array;

FIG. 2 illustrates internal features of one of the cores in FIG. 1;

FIG. 3 illustrates internal features of one of the cores in FIG. 1, specifically with a change to the bit width of a P-register;

FIG. 4 is a flow chart illustrating the method of a state machine to manipulate a 10 bit P-register;

In the various figures of the drawings, like references are used to denote like or similar elements or steps.

### DETAILED DESCRIPTION OF THE INVENTION

In the following description and in the accompanying drawings, specific terminology and drawing symbols are set forth to provide a thorough understanding of the present invention. In some instances, the terminology and symbols may imply specific details that are not required to practice the invention.

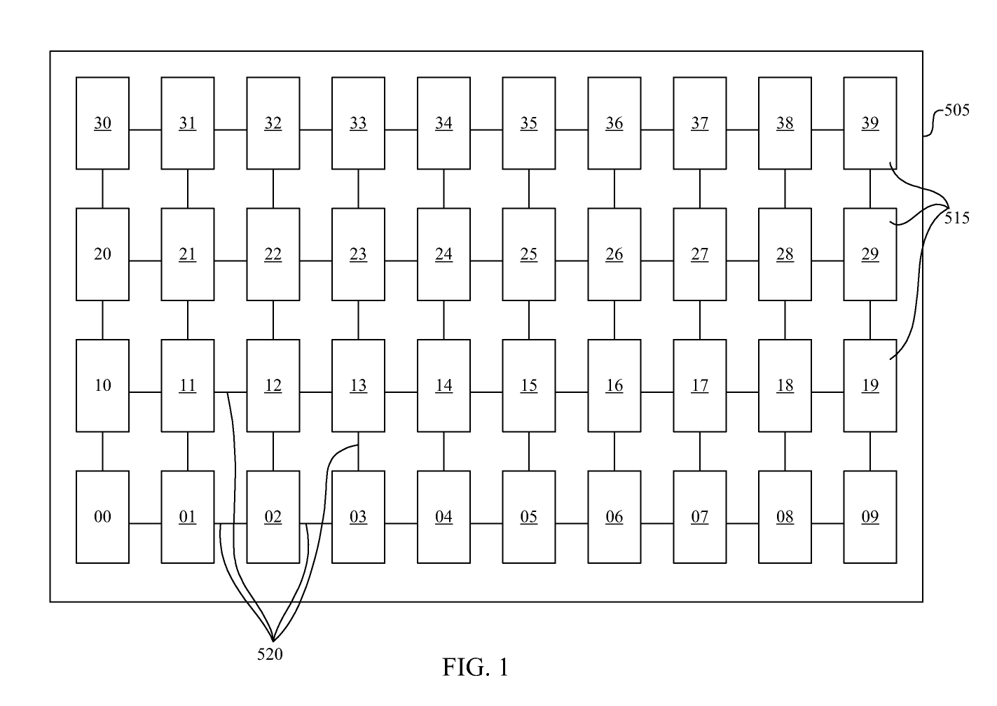

FIG. 1 is a diagrammatic view of a microprocessor 505 having, as an example, a forty member array of computers. Each individual member of this array is sometimes referred to as a “core” or a “node” when the microprocessor 505 is implemented in a single module or on a single semiconductor die. Representative examples of microprocessor 505 cores are computers 515. FIG. 1 shows the array of computers numbered individually 00 to 39. The computers 515 are each a digital processor and interconnected to each other by a plurality of buses, represented by buses 520.

These computers 515 are referred to individually herein in the prior art as a computer core 510a and individually herein as the subject of this invention as a computer core 510b. While microprocessor 505 may be a 40 core array, sold under the registered trademark SEAforth® by IntellaSys® Corporation of Cupertino, Calif., a member of The TPL Group of companies, this invention is not limited to 40 core microprocessors and equally applies to microprocessors with varying numbers of cores. However, for the sake of example, the following discussion references SEAforth® 40 core microprocessors.

The implementation of an extended instruction set mode in accordance with this invention requires minimal modification of existing microprocessor 505 circuitry. The changes to the circuitry first allow activation and deactivation of an extended instruction set mode. Second, the modified circuitry includes instructions which have an alternate execution in the extended instruction set mode while maintaining the same execution of all instructions as in the non-extended instruction set mode. Third, the modified circuitry maintains the same execution of instructions in the extended instruction mode whose function is not modified for execution in the extended instruction set mode.

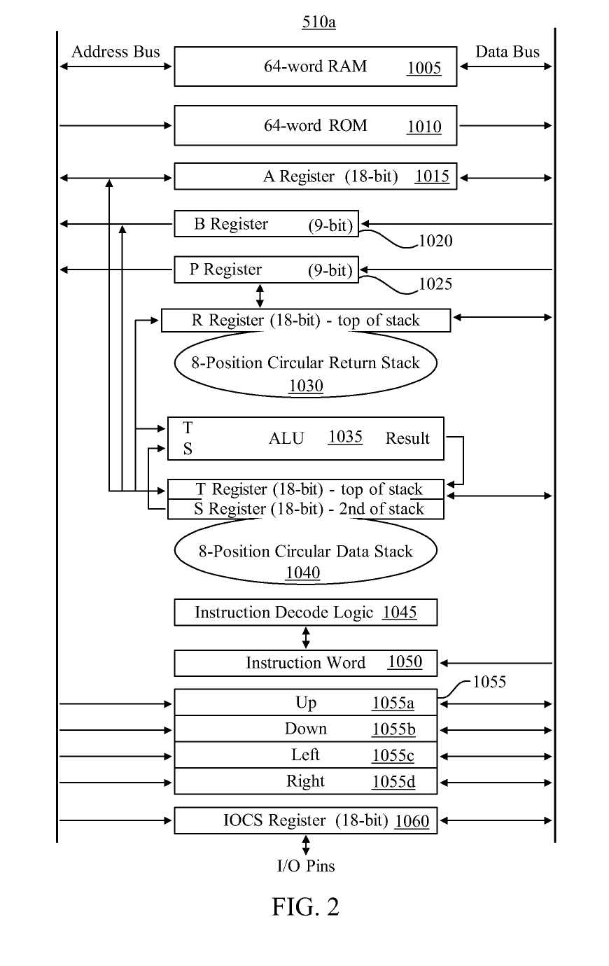

FIG. 2 is a diagrammatic view of internal features of core 510a. It is a digital processor including a 64-word quantity of random access memory (RAM 1005), a 64-word quantity of read only memory (ROM 1010), an 18-bit variable “A” register (A-register 1015), a 9-bit variable “B” register (B-register 1020), and a 9-bit variable “P” register (P-register 1025). Also included are a return stack 1030 with top element of the return stack labeled R, an arithmetic and logic unit (ALU 1035), and a data stack 1040 with top element of the data stack labeled T and second element of the data stack labeled S. Each element, apart of the return stack 1030 and data stack 1040, is an 18-bit register.

An instruction decode logic 1045 decodes an instruction word contained in an instruction word register 1050. An instruction word contains instructions, data, or combinations thereof and is specifically divided into four slots for decode by the logic 1045. Slots 0, 1, and 2 are each five bits wide and are represented by bits 13-17, 8-12, and 3-7 respectively of the instruction word. Slot 3 is three bits wide and is represented by bits 0-2 of the instruction. Further included are four communication ports, collectively referred to as ports 1055 and individually as the up port 1055a, the down port 1055b, the left port 1055c, and the right port 1055d, and an 18-bit input/output control and status register (IOCS-register 1060).

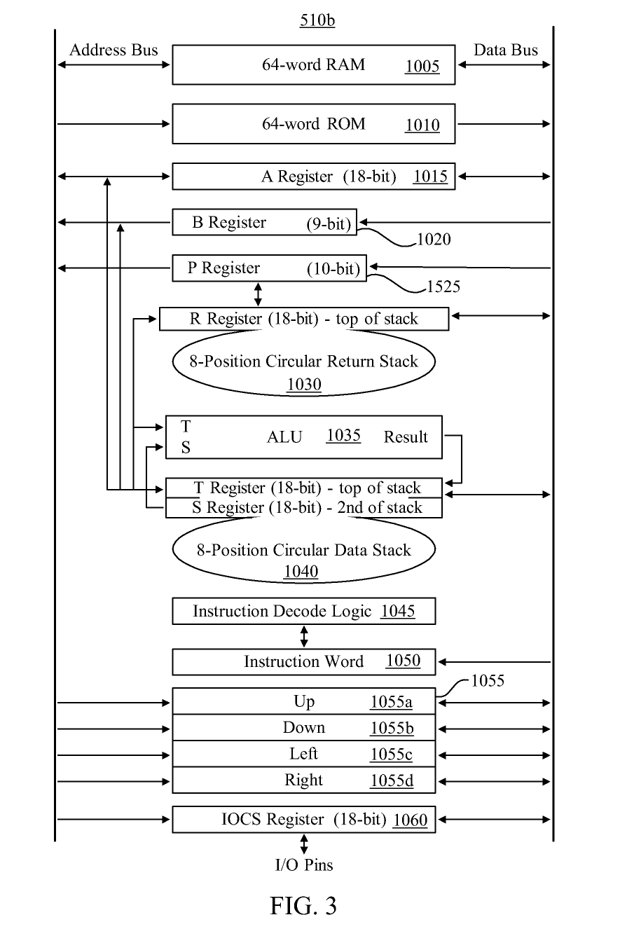

A hardware change to computers 515 as part of the SEAforth® 40 core microprocessor for implementing the extended instruction set mode is the extension of the 9 bit program counter P-register 1025 of FIG. 2 to include a tenth bit. As shown in FIG. 3, core 510b retains the features of core 510a except that it includes a ten bit P-register 1525. The inclusion of a tenth bit in the program counter P-register 1525 of FIG. 3 indicates the state of the extended instruction set mode.

If the tenth bit of the P-register 1525 is set high, the extended instruction set mode is active. Instructions that are executed while the P-register 1525 has its tenth bit set high are executed in the extended instruction set mode. If the tenth bit of the P-register 1525 is set low, the extended instruction set mode is not active. Instructions that are executed while the P-register 1525 has its tenth bit set low are executed in the non-extended instruction set mode.

The 9 low order bits of the P-register 1525 are still the only 9 bits used for addressing. On the other hand, the inclusion of a tenth bit does not change the effect of an instruction which fetched the entire contents of the P-register 1025. Furthermore, an instruction which updates the contents of the P-register 1525 will update the entire P-register 1525 just as it did with 9 bit wide P-register 1025.

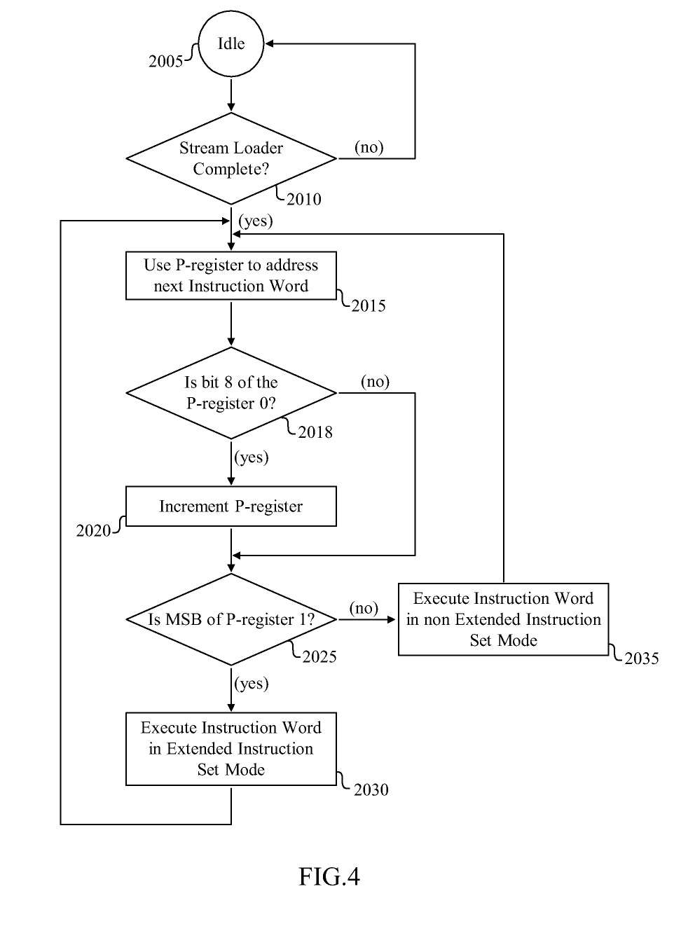

FIG. 4 is a flow chart for the operation of a state machine used in core 510b to manipulate the P-register 1525 during the execution of native machine instruction as part of each word loaded into the instruction word register 1050. In the power up condition, the state machine is in an idle state 2005. In step 2010, the state machine verifies if the stream loader has initialized the registers and stack elements core 510b. If the stream loader is finished in step 2010, then in step 2015 the nine low order bits of the P-register 1525 are used to address the position in the RAM 1005 from which to fetch the first instruction word. Otherwise, the state machine returns to the idle state 2005.

The P-register 1525 is incremented in step 2020. The increment is preferably one. The bits in the P-register have varying significance. As previously mentioned, bit 9 (tenth bit) indicates the extended instruction set. Bit 8, when the P-register is used for addressing, indicates a port (North, South, East, or West). Bit 7, when the P-register 1525 is used for addressing, indicates either RAM or ROM. If bit 7 is set, the address is a word in ROM and if bit 7 is not set, the address is a word in RAM. Bit 6 is ignored in terms of an address and bits 0-5 are used to indicate the specific word of the 64 words in RAM or ROM. An increment to the P-register 1525 will only increment the 6 least significant bits (LSB) so long as the bit 8 is not set. However, the increment will eventually cause the value in the P-register 1525 to wrap.

When each of the six LSB is set to a value of ‘1’, an increment to the P-register 1525 will wrap the 6 LSB back to a value of ‘0’. The most significant bit (MSB) of the P-register 1550 is compared to a value of ‘1’ in step 2025. If the MSB of the P-register 1525 has a value of ‘1’, then the instructions, as part of the instruction word, are executed in the extended instruction set mode in step 2030. If the MSB of the P-register 1525 has a value of ‘0’, then the instructions, as part of the instruction word, are executed in the non-extended instruction set mode in step 2035. The instruction word, as a whole, is considered to be executed either in the extended instruction set mode or in the non-extended instruction set mode, based on the tenth bit of the P-register 1525.

In an alternate embodiment, the step of determining the state of the tenth bit of the P-register 1525 is performed prior to the increment of the P-register 1525. This is because the increment to the P-register 1525 does not affect the MSB of the P-register 1525. In a second alternate embodiment, the step of determining the state of the tenth bit of the P-register 1525 is done prior to loading the instruction word into instruction word register 1050.

The execution of either step 2030 or step 2035 can modify the value in P-register 1525 used to address the next word loaded into the instruction word register. Instructions, as part of the native machine language used to program core 510b that modify P-register 1525, include the following branch instructions: call, return, jump, if, -if, and next. Each instruction can modify the value contained in the P-register 1525. Hence, it is important to always check the state of the tenth bit in a P-register 1525 in step 2025 prior to the execution of the instructions as part of the instruction word; the extended instruction set mode and non-extended instruction set mode are not persistent unless the instructions, as part of the instruction word that are executed, do not modify the tenth bit of the P-register 1525.

A call instruction will modify the tenth bit of the P-register 1525 when the call instruction is located in slot 0 of the instruction word. This is because a slot 0 call leaves thirteen bits in the instruction word for addressing. Only the 10 LSB are used for addressing with a slot 0 call, but those 10 bits replace the existing value in the P-register 1525 when the call instruction is executed.

A return instruction will replace the value of the P-register 1525 when the instruction is executed from a slot 0, 1, or 2. The instruction fetches the 10 LSB of the top element R-register of the return stack 1525 and replaces the value in the P-register 1525 from which to fetch the next instruction word.

A jump instruction, similarly to a call instruction, will modify the tenth bit of the P-register 1525 when the jump instruction is located in slot 0 of the instruction word. This is because a slot 0 jump leaves thirteen bits in the instruction word for addressing. Only the 10 LSB are used for addressing with a slot 0 jump, but those 10 bits replace the existing value in the P-register 1525 when the jump instruction is executed.

A coroutine instruction, similarly to a return instruction, will replace the value of the P-register 1525 when the instruction is executed from a slot 0, 1, or 2. The instruction fetches the 10 LSB of the top element R-register of the return stack 1030 and replaces the value in the P-register 1525 from which to fetch the next instruction word.

An if instruction can modify the tenth bit of the P-register 1525 when the if instruction is located in slot 0 of the instruction word. This is because a slot 0 if leaves thirteen bits in the instruction word for addressing. Only the 10 LSB are used for addressing with a slot 0 if, but those 10 bits replace the existing value in the P-register 1525 when the branch address associated with the if instruction is used. The branch address, located in the instruction word with the if instruction in slot 0, will replace the P-register 1525 with the branch address when the top element T-register of the data stack 1040 is zero.

A -if instruction, similarly to an if instruction, can modify the tenth bit of the P-register 1525 when the -if instruction is located in slot 0 of the instruction word. This is because a slot 0 -if leaves thirteen bits in the instruction word for addressing. Only the 10 LSB are used for addressing with a slot 0 -if, but those 10 bits replace the existing value in the P-register 1525 when the branch address associated with the -if instruction is used. The branch address located in the instruction word with the -if instruction in slot 0 will replace the P-register 1525 with the branch address when the top element T-register of the data stack 1040 is positive, sometimes referred to as the T-register, having its most significant bit set to a value of ‘0’.

A next instruction can modify the tenth bit of the P-register 1525 when the next instruction is located in slot 0 of the instruction word. This is because a slot 0 next leaves thirteen bits in the instruction word for addressing. Only the 10 LSB are used for addressing with a slot 0 next, but those 10 bits replace the existing value in the P-register 1525 when the branch address associated with the next instruction is used. The branch address, located in the instruction word with the next instruction in slot 0, will replace the P-register 1525 with the branch address when the top element R-register of the return stack 1030 is non-zero.

The foregoing description details specific embodiments of the invention and is included for illustrative purposes. However, it will be apparent to one skilled in the art that many combinations and permutations of the described embodiments are possible while remaining within the scope and spirit of the invention. While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. A method for executing an instruction by a microprocessor comprising executing the instruction in an extended instruction set mode if a significant bit of a register is set.

2. The method of claim 1 wherein the microprocessor comprises one or more RISC cores.

3. The method of claim 1 wherein the significant bit is set by a branch instruction.

4. The method of claim 1 wherein the register comprises a program counter register.

5. A method for executing an instruction by a microprocessor comprising:
a) using low order bits in a program counter register to address a location from which to execute the instruction;
b) incrementing the register;
c) determining if a most significant bit of the register is set; and
d) executing the instruction in an extended instruction set mode if the most significant bit of the register is set.

6. The method of claim 5 wherein the microprocessor comprises one or more RISC cores.

7. The method of claim 5 wherein the significant bit is set by a branch instruction.

8. A method for executing an instruction by a microprocessor comprising:
initializing registers by means of a stream loader;
using low order bits in a program counter register to address a location from which to execute an instruction word;
incrementing the program counter register;
determining if a status of a most significant bit of the program register is set; and
executing the instruction word in the extended instruction set mode if the status is set.

9. The method of claim 8 wherein the microprocessor comprises one or more RISC cores.

10. The method of claim 8 wherein the significant bit is set by a branch instruction.

11. A method for executing an instruction by a microprocessor comprising:
initializing registers by means of a stream loader;
using low order bits in a program counter register to address a location from which to execute an instruction word;
determining the status of an increment bit;
incrementing the program counter register if the increment bit is set;
determining if a status of a most significant bit of the program register is set; and
executing the instruction word in the extended instruction set mode if the status is set.

12. The method of claim 11 wherein the microprocessor comprises one or more RISC cores.

13. The method of claim 11 wherein the significant bit is set by a branch instruction.

14. A microprocessor comprising an extended instruction set mode and a register comprising a significant bit, wherein the status of the bit indicates if the extended instruction mode is enabled.

15. The microprocessor of claim 14 wherein the register is a program counter register.

16. The microprocessor of claim 14 wherein the microprocessor further comprises one or more RISC cores.
